(19) United States
(12) Patent Application Publication
(10) Pub. No.: US 2023/0136341 A1
(43) Pub. Date: May 4, 2023

(54) A DISPOSABLE URINARY AND FECES POT

(71) Applicant: GEORGIOS TSEKOURAS, MYKONOS (GR)

(72) Inventor: GEORGIOS TSEKOURAS, MYKONOS (GR)

(21) Appl. No.: 17/912,205

(22) PCT Filed: Aug. 6, 2020
(86) PCT No.: PCT/GR2020/000039

§ 371 Date: Sep. 16, 2022

(30) Foreign Application Priority Data
Mar. 23, 2020 (GR) 20200100155

(51) Int. Cl. A47K 11/02

(52) U.S. Cl. CPC A47K 11/026

(57) ABSTRACT

The invention refers to a disposable, rectangular parallelepiped shaped, urinary and faeces pot. The pot consists of an outer shell (3) and an inner lining (4), which may be removable. It has two further extensions (2) to hold it. The pot may have pleats at the bottom (5), front (6) and back (7) to vary its volume; it may have adhesive tapes (8) to stick between the buttocks and thighs of the user, while it can have a valve (9) on its underside (5) for urine drainage A part or all of the pot can be made of water-soluble or biodegradable materials.

### FIELD OF ART

The invention relates to the field of human needs art and more specifically to the field of hygiene. In particular it refers to the field of preparations and items for personal health purposes in the toilet. Specifically, it refers to a disposable urinary and faeces pot.

### BACKGROUND OF THE INVENTION

The urinary and faeces pot disclosed in the present invention has not been disclosed in the prior art.

It is well known and commonly accepted that the majority of women who have to urinate and defecate while away from home, a hotel or a familiar environment generally avoid performing these basic needs in public and communal toilets. Especially in public places, with high traffic, such as shopping malls or restaurants and entertainment stores, but also in places where there may be shared use of toilets by men and women, avoiding the use and suppressing these basic needs is still done more imperative. The same condition, though perhaps to a lesser extent, applies to multiple men.

The reason is obvious, since there is always the risk of possible infection of the posterior surface of thighs, buttocks and the genital and anal area, either by direct contact or indirectly by the bounce of dirty and contaminating drops from the stagnant fluid in the interior of the toilet.

To date, users in western type toilets usually adjust their posture by bending their hips and knees in such a way that their anal and genital area is perpendicular and at least 10 cm away from the toilet. This prevents body from directly contacting the toilet, but without preventing the possible bounce of liquids from inside the toilet. In addition, it is not ensured that the clothes and especially the lowered underwear of the user will not come into contact with the outside of the toilet, due to the posture, which inevitably and especially in shared toilets is an additional source of microbes.

Alternatively and for cautious users, there are products on the market that aim to cover the rim of the toilet, with disposable materials, such as paper or nylon. After all, they also aim at partial protection of the user, since only the rim is covered and protection against indirect bounce resulting from liquids inside the toilet is not ensured. Often and in order to further protect against stagnant wastewater in the toilet, many users throw papers into the toilet from the beginning to create a layer that will prevent any bounce. Of course, this half meter is against the protection of the environment, as there is waste of paper, while at the same time it can contribute to the blockage of the sewer pipe, causing more significant problems to the installation.

It is thus an object of the present invention to advantageously deal with the aforementioned disadvantages and shortcomings of the prior art by proposing a disposable urinary and faeces pot.

It is a further object of the present invention to provide a disposable urinary and faeces pot, which is made of biodegradable or waterdegradable polymeric materials.

It is a further object of the present invention to provide a disposable urinary and faeces pot, which is waterproof, flexible, with a soft texture, so that it is provided pre-folded, in small dimensions and can be developed in its normal dimensions, by the user, during use.

A further feature of the invention is the fact that it can be placed even on the lid of the toilet or on the floor, in order to completely avoid contact with the dirty liquids inside the toilet, while its subsequent disposal takes place either entirely in the toilet, if it is made of a water-permeable material, either its contents in the toilet and the urinary/faeces pot in the waste bin.

A further advantage of the invention is the fact that the user contact with the toilet rim is completely avoided, since there is no direct connection between the toilet and urination or defecation.

Another advantage of the invention is that it completely eliminates the possibility of contamination of the genital and anal area, but also the staining of users' clothes by the bouncing of liquids from inside the toilet.

In addition, an indirect advantage of using the urinary/faeces pot of the invention is that it is avoided the possibility of urinary tract infections from prolonged urine retention in the bladder in the case of users who avoid visiting public toilets.

An advantage of the present invention is also the fact that the user does not come into contact with the contents of the devices used.

These and other objects, features and advantages of the invention will become apparent in the following detailed description.

### BRIEF DESCRIPTION OF THE DRAWINGS

The invention will become apparent to those skilled in the art with reference to the accompanying drawings in which it is illustrated in a non-limiting manner.

FIGS. 1 (a)-(b) show in front section and in perspective view an indicative embodiment of the invention, with its four handles.

FIGS. 2 (a)-(b) show an alternative embodiment of the invention, both in partial section and in perspective view.

FIGS. 3 (a)-(b) show another illustrative alternative embodiment of FIGS. 2 (a)-(b), with a liquid drain valve from inside the pot.

FIGS. 4 (a)-(e) show illustrative embodiments of how to use the disposable urinary/faeces pot of the present invention.

FIGS. 5 (a)-(b) show another variant of the invention.

### DETAILED DESCRIPTION OF PREFERRED EMBODIMENT

Referring now to the accompanying figures we will describe illustrative embodiments of the disposable urinary/faeces pot of the invention, in order to make its technical characteristics and advantages obvious.

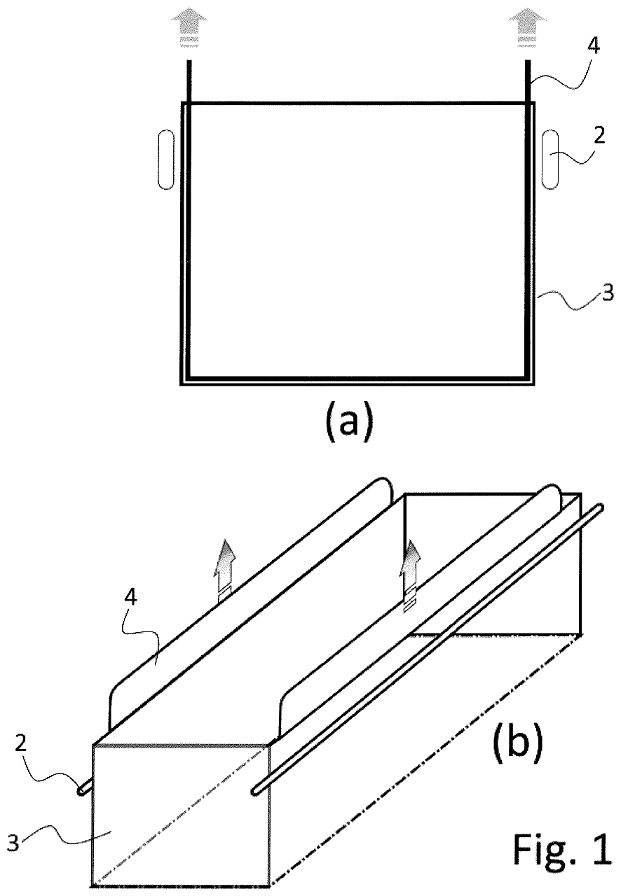

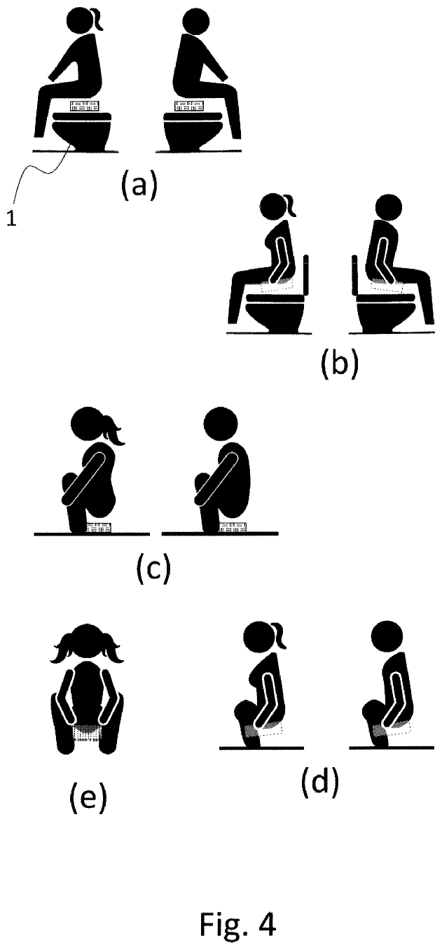

As shown in FIGS. 4 (a), (c) the urinary pot of the invention can be placed in any space, either by resting it on the closed lid of a toilet (1), or on the floor, or even by holding it a few centimetres above the toilet (1). The urinary/faeces pot of the invention has a rectangular parallelepiped shape, FIG. 1 (a), with the upper side open. The device is placed under normal conditions between the central half of the user's thighs, while at the same time serving his/her genital and anal area. The pot has at least two extensions (2), FIG. 1 (b), extending to the upper front and upper rear side of the pot, so that the user can hold it with his/her fingers. The extensions (2) may not be two and single, but they can be four and protrude from the front and back side, performing exactly the same function.

The device may be made of two layers, the outer shell (3) and the inner lining (4), each body being easily detached from the other. In such a case, the outer shell (3) may be made of semi-hard paper, pulp or cardboard in order to maintain its structure during use, while the inner lining (4) may be made of a thin water soluble polymer sheet. For example, without being limited to, one such material is polyvinyl alcohol, which can be processed to form polymeric films for such use. In such a case, the detachable inner lining (4), after the end of the physical operation, is removed and discarded together with the contents, inside the toilet (1), since there is no risk of residues. The outer shell (3) is left adjacent to the toilet and can likewise be recycled through known, appropriate actions.

In an alternative embodiment of the invention, the outer shell (3) may likewise be of water-soluble cardboard or other water-soluble material and thus the entire pot, together with the contents, may be thrown into the toilet (1) without the risk of producing non-degradable waste.

In another alternative embodiment of the invention, the outer shell (3) and the inner lining (4) may be properly welded together, making it impossible to detach from each other. In such a case, if the outer shell is not water-soluble, it is recommended to use the pot only for urine, as the faeces may settle inside the pot, resulting in reduced hygiene in the toilet area.

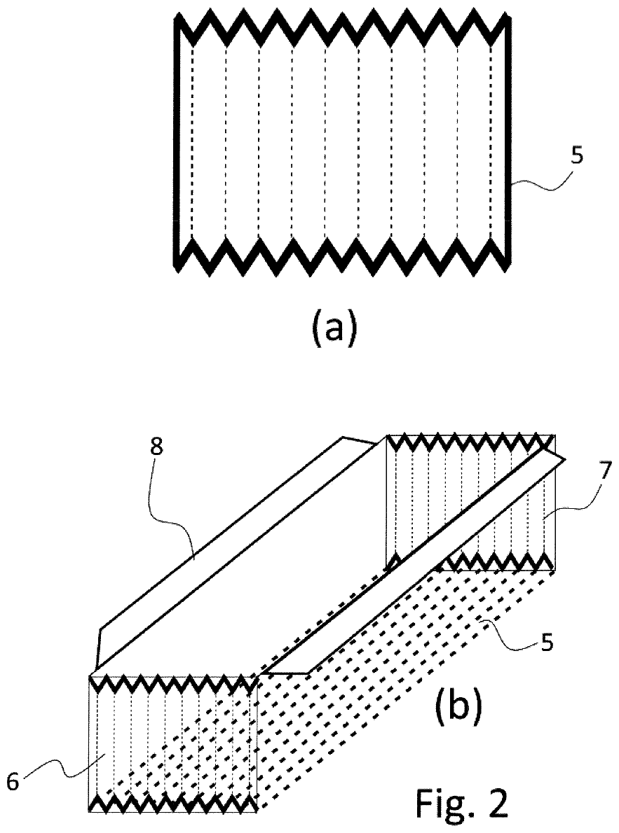

In yet another illustrative embodiment of the invention, the pot may by design be size-variable on its underside (5), but also on its front (6) and back (7) one, FIG. 2 (b). For example, without being limited to, this size can reach up to 50% of the original dimension. So, there will be a reduced initial size in the pot and it will be even easier to transport. This pleated surface, FIG. 2 (a), is possible with any type of paper or respective soft material to be used for said pot. In addition, the pot has further adhesive tapes (8), along its upper surfaces. In this way the user may hold the pot more easily between the inner surfaces of the two thighs and the two buttocks, i.e. at the genital and anal area. In this way the user will more easily hold the pot either a few centimetres above the rim of the toilet (1), FIG. 4 (b), or adjacent to the toilet (1) and inside the room, FIG. 4 (d), if space and sanitation allow.

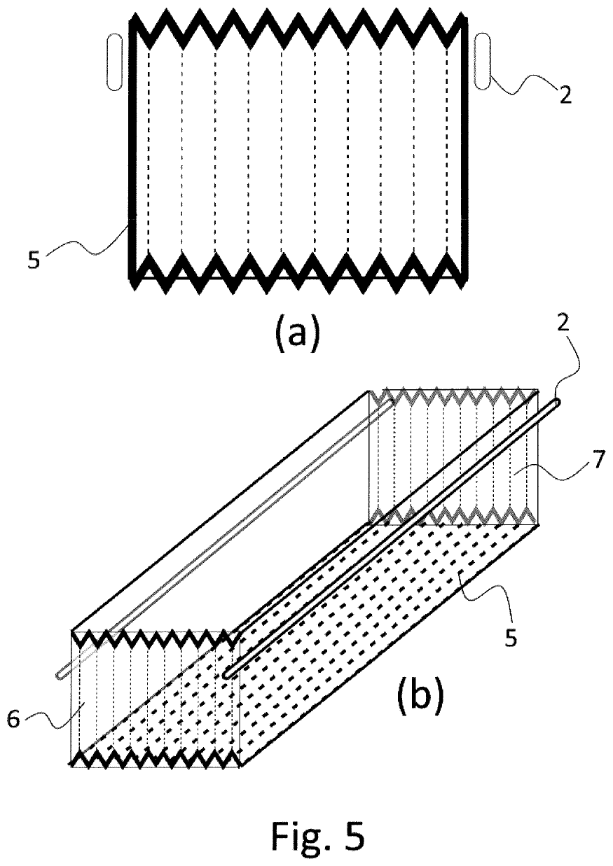

In yet another indicative variant of the invention, the pot may have extensions (2), the outer shell (3) with the inner lining (4) being properly welded together. At the same time the lower side (5), FIG. 5 (a), but also the front (6) and back side (7) of the pot, FIG. 5 (b), will be of variable size. The material of the outer shell (3) is either of paper, pulp, cardboard, or of a suitable water-degradable or biodegradable hard material, while the inner lining (4) is of a thin water-soluble or biodegradable polymer sheet. In such a variant the pot cannot be held, due to its weight, by using adhesive tapes (8) between the thighs of the user.

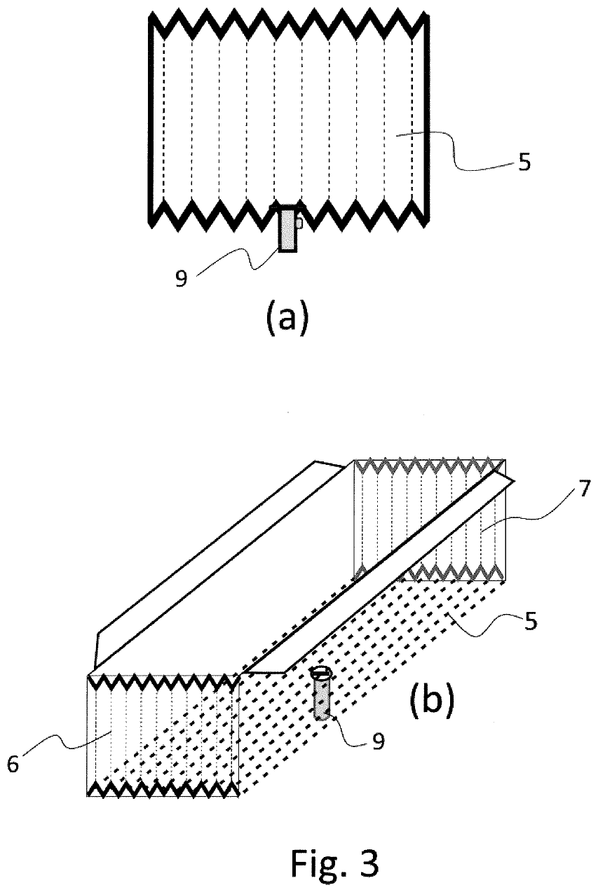

In an additional proposed alternative embodiment, the pot may further have a drain valve (9), FIG. 3 (b) to empty its contents, if it is of course urine. The drain valve (9) must be located in the centre of the lower side (5). By applying pressure to the valve, FIG. 3 (a) the user will be able to extract urine into the toilet (1) if the pot material is not water-soluble. Then, by folding it to a small volume, the pot can be discarded in the trash bin.

Recommended materials for the construction of both the outer shell (3) and the inner lining (4) are, in addition to water-soluble materials, biodegradable materials, which can be converted to CO₂, biomass, salts or any other useful for the environment material. In addition, the size of the pot should be different for adults and different for children, although this is not mandatory.

It should be noted at this point that the description of the invention has been made with reference to illustrative embodiments, not being limited to those. Therefore, any change or modification in terms of shape, dimensions, morphology, materials used and manufacture components, as long as they are not a new inventive step and do not contribute to the technical development of the already known are considered to be contained in the purposes and aspirations of the present invention.

1. A disposable urinary and feces pot, comprising an outer shell (3) and an inner lining (4), in rectangular parallelepiped shape, said pot has at least two extensions (2) extending to an upper front and an upper rear side to to form said pot

2. The disposable urinary and feces pot, according to claim 1, wherein said inner lining (4) is detachable from said outer shell (3)

3. The disposable urinary and feces pot, according to claim 1, wherein the underside (5), the front (6) and the rear (7) sides of said pot are variable in width up to 50% of the original dimension of said pot.

4. The disposable urinary and feces pot, according to claim 1, wherein said pot has self-adhesive tapes (8) along the upper surfaces.

5. The disposable urinary and feces pot, according to claim 1, wherein said underside (5) has a drain valve (9).

6. The disposable urinary and feces pot, according to claim 1 wherein, said inner lining (4) is made of a water-soluble material.

7. The disposable urinary and feces pot, according to claim 1 wherein said outer shell (3) is made of a water-soluble material.
